(19) United States
(12) Patent Application Publication
(10) Pub. No.: US 2024/0173733 A1
(43) Pub. Date: May 30, 2024

(54) DISPENSER

(71) Applicants: TAISEI KAKO CO., LTD., Osaka (JP); YUWA SHOJI CO., LTD., Tokyo (JP)

(72) Inventors: Yukihiro OGAWA, Osaka (JP); Hidenari NISHIKURA, Osaka (JP); Tsutomu TANAKA, Tokyo (JP)

(73) Assignees: TAISEI KAKO CO., LTD., Osaka (JP); YUWA SHOJI CO., LTD., Tokyo (JP)

(21) Appl. No.: 18/551,855

(22) PCT Filed: Mar. 22, 2022
(86) PCT No.: PCT/JP2022/013279

§ 371 Date: Sep. 21, 2023

(30) Foreign Application Priority Data
Mar. 22, 2021 (JP) 2021-047328

(51) Int. Cl. B05B 11/10

(52) U.S. Cl. CPC B05B 11/1087; B05B 11/1047

(57) ABSTRACT

A dispenser includes: a container that stores a liquid; a pump unit, and a cover member for housing the pump unit in the container. The pump unit includes: a liquid delivery mechanism configured to take a liquid suction action and a liquid delivery action; a case part in which the liquid delivery mechanism is arranged and has an inner communication hole for providing air communication between the inside and the outside of the case part; and an inner opening-closing part that opens the inner communication hole in the liquid delivery action of the liquid delivery mechanism, and closes the inner communication hole in the liquid suction action. The cover member includes: a cover body that has an outer communication hole for providing air communication between the inside and outside of the case part; and an outer opening-closing part that opens and closes the outer communication hole according to the pressure in the container.

### CROSS-REFERENCE TO RELATED APPLICATION

This application claims priority to Japanese Patent Application No. 2021-47328, the disclosure of which is incorporated herein by reference in its entirety.

### TECHNICAL FIELD

The present invention relates to a dispenser including a pump for discharging a liquid that is stored therein.

### BACKGROUND

As the aforementioned dispenser, a dispenser 9 as shown in FIG. 11 including a container 90 for storing a liquid and a pump head 91 with a pump attached to a mouth of the container 90 is known (see, for example, Patent Literature 1).

The pump head 91 with a pump includes: a cylinder member 910 having a cylindrical shape to be fixed to the mouth while being arranged in the container 90; a pump 911 including a rod member 9110 that vertically extends in the cylinder member 910, a liquid passage tube 9111 having a cylindrical shape and being fit onto the rod member 9110 to be reciprocally movable, and a return spring 9112 that biases the liquid passage tube 9111 in the direction in which the liquid passage tube 9111 is pushed upward; a piston 912 arranged in the cylinder member 910 while being fixed to the liquid passage tube 9111; and a push down head 913 that is pushed down by a user, in which the fluid tube 9111 and the piston 912 are fixed to the push down head 913.

In the dispenser 9 of the above configuration, the liquid passage tube 9111 and the piston 12 move downward when the push down head 913 is pushed downward by the user. When the liquid passage tube 9111 moves downward, the rod member 9110 enters the liquid passage tube 9111. This decreases the volume of the liquid passage tube 9111 to discharge the liquid in the liquid passage tube 9111 to the outside the liquid passage tube 9111 (see FIG. 12).

Then, when the user releases the hand from the push down head 913, the liquid passage tube 9111 and the piston 912 are pushed upward by the return spring 9112. When the liquid passage tube 9111 moves upward, the rod member 9110 is retracted from the inside of the liquid passage tube 9111. This increases the volume of the liquid passage tube 9111 to draw the liquid in the container 90 into the liquid passage tube 9111.

Further, although the inside of the container 90 becomes a negative pressure when the liquid stored in the container 90 is drawn into the liquid passage tube 9111, the outside air is drawn into the container 90 through a suction hole 9100 provided to pass through the cylinder member 910. Thus, such a negative pressure is eliminated.

In this way, the dispenser 9 of the above configuration can discharge the liquid stored in the container 90.

Meanwhile, the conventional dispenser 9 is configured, as described above, to eliminate the negative pressure in the container 90 by the air drawn into the container 90 through the suction hole 9100 when the pump 911 suctions the liquid stored in the container 90. However, the suction hole 9100 is sometimes clogged before a sufficient amount of air is drawn into the container 90 if, for example, the pump head 91 is rapidly and continuously pushed down. In this case, the negative pressure in the container 90 is increased every time the pump head 91 is pushed down.

In such a situation, there was a case where the liquid in the container 90 could not be drawn into the pump 911 even where the liquid passage tube 9111 has moved upward. This sometimes caused liquid discharge failure.

### CITATION LIST

### Patent Literature

Patent Literature 1: JP H6-57843 U

### SUMMARY

### Technical Problem

In view of such circumstances, an object of the present invention is to provide a dispenser capable of suppressing the occurrence of discharge failure of a liquid stored therein.

### Solution to Problem

A dispenser of the present invention including:
a container that stores a liquid;
a pump unit that is attached to a mouth of the container; and
a cover member that is arranged in the container and has a space in which the pump unit can be arranged, in which
the pump unit includes:
   a liquid delivery mechanism that is configured to take a liquid suction action to suction the liquid in the container, and take a liquid delivery action to deliver the liquid suctioned from the inside of the container;
   a case part that has a space in which the liquid delivery mechanism is arranged and has an inner communication hole for providing air communication between the inside and the outside of the case part; and
   an inner opening-closing part that is configured to open the inner communication hole by the liquid delivery action of the liquid delivery mechanism, and close the inner communication hole by the liquid suction action of the liquid delivery mechanism, and
the cover member includes:
   a cover body that is configured to form a storage space continuing from an inside of the case part through the inner communication hole between the case part and the cover body, while covering the case part in the container, and has an outer communication hole formed to communicate with the storage space and the inside of the container; and
   an outer opening-closing part that is configured to open the outer communication hole when an inner pressure of the container is lower than the inner pressure of the storage space, and close the outer communication hole when the inner pressure of the container is higher than the inner pressure of the storage space.

In the dispenser of the present invention, it can be configured such that
the case part has one end arranged on a mouth side of the container and an other end arranged on a bottom wall side of the container,
the cover body has one end arranged on the mouth side of the container and an other end arranged on the bottom wall side of the container,
the inner communication hole is formed on the one end side of the case part, and
the outer communication hole is arranged on the other end side of the cover body.

In the dispenser of the present invention, it can be configured such that
the inner opening-closing part is configured to, while being in tight contact with an inner peripheral surface of the case part, move in a direction from the one end side of the case part toward the other end side of the case part in the liquid delivery action of the liquid delivery mechanism, and move in a direction from the other end side of the case part toward the one end side of the case part in the liquid suction action of the liquid delivery mechanism,
the inner opening-closing part is configured to be arranged at a closing position to cover the inner communication hole by the movement of the case part in the direction from the other end side toward the one end side, and be retracted from the closing position by the movement of the case part in the direction from the one end side toward the other end side.

### BRIEF DESCRIPTION OF DRAWINGS

FIG. 1 is an external view of a dispenser according to an embodiment of the present invention.

FIG. 2 is an exploded view of the dispenser according to the embodiment.

FIG. 3 is a longitudinal sectional view of the dispenser according to the embodiment.

FIG. 4 is an enlarged view of a pump unit of the dispenser according to the embodiment.

FIG. 5A is an explanatory view of a state where an air supply path is opened at the time of a liquid delivery action of a liquid delivery mechanism.

FIG. 5B is an explanatory view of a state where an intake path is opened at the time of a liquid suction action of the liquid delivery mechanism.

FIG. 6 is an explanatory view of the action of the dispenser according to the embodiment in a non-operated state.

FIG. 7 is an explanatory view of the action of the dispenser according to the embodiment in an operated state.

FIG. 8 is an explanatory view of the action of the dispenser according to the embodiment in a state where a pump head pushed down by a user's hand is released from the hand.

FIG. 9 is an explanatory view of a dispenser according to another embodiment of the present invention in a non-operated state.

FIG. 10 is an explanatory view of the dispenser according to the embodiment in an operated state.

FIG. 11 is an explanation view of a conventional dispenser before a liquid stored therein is discharged.

FIG. 12 is an explanatory view of the conventional dispenser after the liquid stored therein is discharged.

### DESCRIPTION OF EMBODIMENTS

Hereinafter, a dispenser according to an embodiment of the present invention will be described with reference to the attached drawings.

The dispenser includes a container for storing a liquid and a pump for discharging the liquid from the container. In this embodiment, the following description will be given by taking, for example, the dispenser configured to discharge the liquid in a foam form from the container.

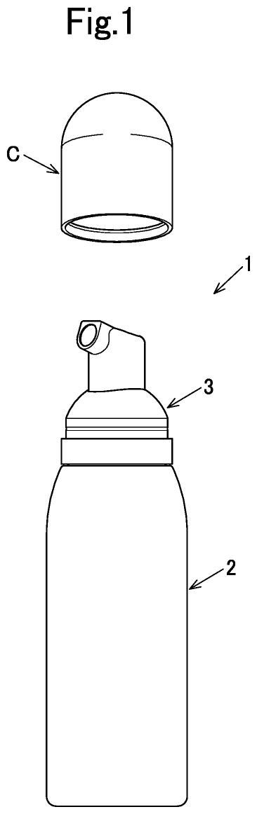

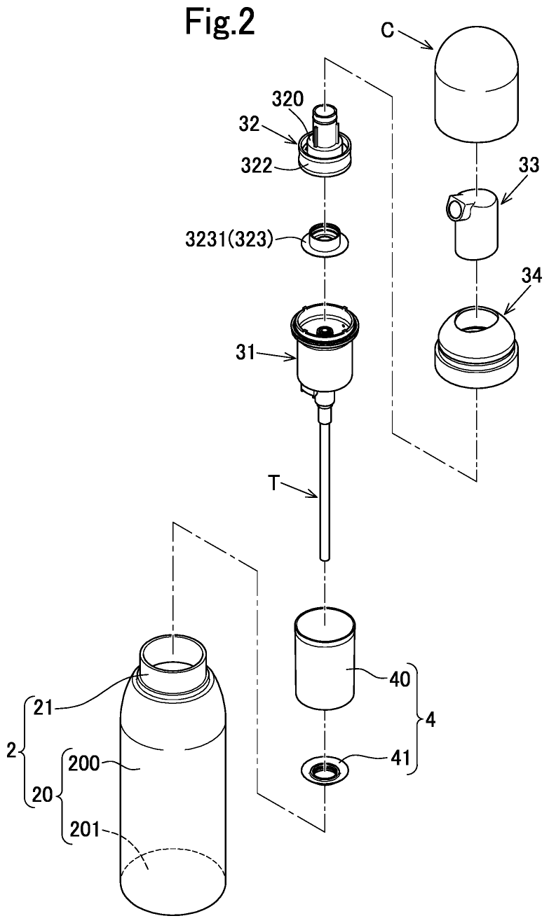

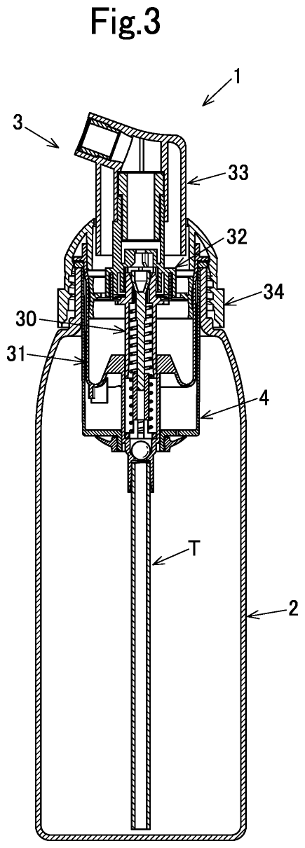

The dispenser 1 according to this embodiment includes, as shown in FIG. 1, a container 2 for storing the liquid, a pump unit 3 attached to a mouth of the container 2, and, as shown in FIG. 2 and FIG. 3, a cover member 4 arranged in the container 2 and having a space capable of allowing a part of the pump unit 3 to be arranged therein.

The dispenser 1 of this embodiment includes a cap C for covering the pump unit 3 (see FIG. 1), but can be provided without the cap C.

As shown in FIG. 2, the container 2 includes a bottomed storing part 20 and a cylindrical mouth 21 that is integrally formed with one end of the container 20.

The storing part 20 has a cylindrical container body 200 and a container bottom wall 201. The outer diameter of the mouth 21 is smaller than the outer diameter of the container body 200.

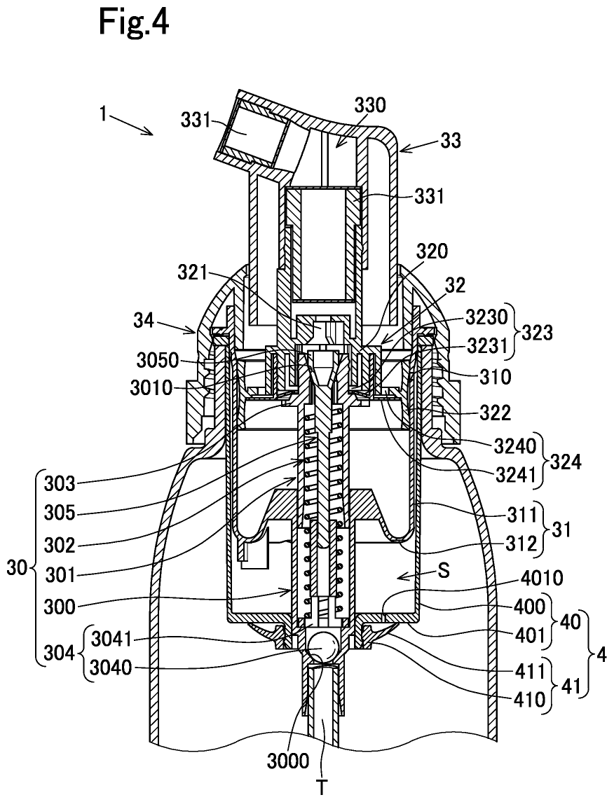

As shown in FIG. 3, the pump unit 3 includes: a liquid delivery mechanism 30 that is configured to take a liquid suction action to suction the liquid in the container 2 and take a liquid delivery action to deliver the liquid suctioned from the inside of the container 2; a case part 31 that has a space in which the liquid delivery mechanism 30 is arranged and has an inner communication hole 310 (see FIG. 4) for providing air communication between the inside and the outside of the case part; an air-liquid mixing part 32 configured to feed air to the liquid delivery mechanism 30 for mixing with the liquid by the liquid delivery action of the liquid delivery mechanism 30; a pump head 33 having a flow path for discharging the liquid delivered from the liquid delivery mechanism 30 to the outside; and a retainer 34 that is fixed to the mouth 21 of the container 2.

As shown in FIG. 4, the liquid delivery mechanism 30 includes:

a fixed cylindrical part 300 that has a cylindrical shape, is fixed inside the case part 31, and includes a liquid suction port 3000 formed at one end (i.e., lower end) in an axial direction to allow the liquid suctioned from the inside of the container 2 to pass therethrough; a movable cylindrical part 301 that has a cylindrical shape, is slidably fitted into the fixed cylindrical part 300, and includes a liquid delivery port 3010 formed at one end in the axial direction to allow the liquid to be delivered toward the pump head 33 to pass therethrough; a biasing device 302 that biases the movable cylindrical part 301 in a direction in which the movable cylindrical part 301 advances from the fixed cylindrical part 300; a flange 303 that protrudes outward (i.e., radially outward of the movable cylindrical part 301) from an outer peripheral surface of the movable cylindrical part 301; a suction valve 304 that is configured to open the liquid suction port 3000 of the fixed cylindrical part 300 by the liquid suction action and close the liquid suction port 3000 of the fixed cylindrical part 300 by the liquid delivery action; and a delivery valve 305 that is configured to close the liquid delivery port 3010 of the movable cylindrical part 301 by the liquid suction action and open the liquid delivery port 3010 of the movable cylindrical part 301 by the liquid delivery action.

The fixed cylindrical part 300 is formed integrally with the case part 31. An insertion port for inserting the movable cylindrical part 301 is formed at the other end (i.e., upper end) in the axial direction of the fixed cylindrical part 300. Note that a tubular pipe T is attached to the lower end of the fixed cylindrical part 300 of this embodiment.

A communication port that is opened inside the fixed cylindrical part 300 is formed at the other end (i.e., lower end) in the axial direction of the movable cylindrical part 301. The liquid delivery port 3010 of the movable cylindrical part 301 communicates with a mixing chamber 321 of the air-liquid mixing part 32 to be described later.

The biasing device 302 is a compression spring and arranged to extend between the inside of the fixed cylindrical part 300 and the inside of the movable cylindrical part 301.

The flange 303 is formed on the upper end side of the movable cylindrical part 301. Also, the flange 303 of this embodiment is formed to be continuous along the entire circumference of the movable cylindrical part 301.

The suction valve 304 includes a ball 3040 that is arranged in the lower end part of the fixed cylindrical part 300 and a ball stopper 3041 that limits the area in which the ball 3040 moves in the lower end part of the fixed cylindrical part 300 (i.e., the area in which the ball 3040 moves from the lower end side of the fixed cylindrical part 300 to the upper end side).

The ball 3040 is configured to be held in contact with the entire circumference of the inner peripheral surface of the lower end part of the fixed cylindrical part 300 during the liquid delivery mechanism 30 takes the liquid delivery action, and to be kept away from the inner peripheral surface of the lower end part of the fixed cylindrical part 300 during the liquid delivery mechanism 30 takes the liquid suction action.

The liquid suction port 3000 is closed when the ball 3040 is held in contact with the entire circumference of the inner peripheral surface of the lower end part of the fixed cylindrical part 300. The liquid suction port 3000 is opened when the ball 3040 is kept away from the inner peripheral surface of the lower end part of the fixed cylindrical part 300.

Further, when the ball 3040 separates from the inner peripheral surface of the lower end part of the fixed cylindrical part 300 by the liquid suction action of the liquid delivery mechanism 30, the ball 3040 moves from the lower end side to the upper end side of the fixed cylindrical part 300. The ball stopper 3041 is configured to receive the ball 3040 that moves from the lower end side to the upper end side of the fixed cylindrical part 300.

The delivery valve 305 has an opening-closing shaft part 3050 that has a shaft shape and is configured to slide relative to the movable cylindrical part 301 (i.e., slide in the axial direction of the movable cylindrical part 301 relative thereto) while being inserted into the movable cylindrical part 301.

The opening-closing shaft part 3050 is formed to have its outer diameter increasing toward the distal end side (i.e., upper end side). Thus, when the movable cylindrical part 301 slides downward relative to the opening-closing shaft part 3050, the opening-closing shaft part 3050 separates from the inner peripheral surface of the upper end part of the movable cylindrical part 301, and when the movable cylindrical part 301 slides upward relative to the opening-closing shaft part 3050, the opening-closing shaft part 3050 is held in contact with the inner peripheral surface of the upper end part of the movable cylindrical part 301.

When the liquid delivery mechanism 30 takes the liquid delivery action, the movable cylindrical part 301 slides downward relative to the opening-closing shaft part 3050, and thus the opening-closing shaft part 3050 separates from the inner peripheral surface of the upper end part of the movable cylindrical part 301. Thus, the liquid delivery port 3010 is opened. On the other hand, when the liquid delivery mechanism 30 takes the liquid suction action, the movable cylindrical part 301 slides upward relative to the opening-closing shaft part 3050, and thus the opening-closing shaft part 3050 is held in contact with the inner peripheral surface of the upper end part of the movable cylindrical part 301. Thus, the liquid delivery port 3010 is closed.

The case part 31 has a bottomed cylindrical shape. Further, the case part 31 has a cylindrical case body 311 and a case bottom wall 312 arranged to face the container bottom wall 201 side.

The inner communication hole 310 is formed to provide air communication between the inside and the outside of the case body 311. Also, the inner communication hole 310 is formed on the upper end side of the case body 311 (i.e., opposite side to the case bottom wall 312).

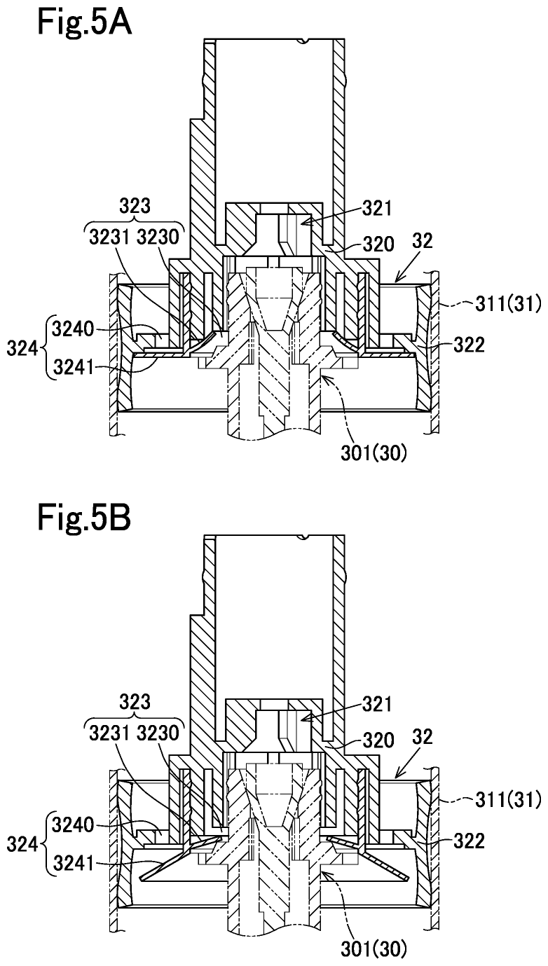

As shown in FIG. 5A and FIG. 5B, the air-liquid mixing part 32 includes: a base part 320 that is fixed to the outer peripheral surface of the movable cylindrical part 301; a mixing chamber 321 that forms a space for mixing the liquid delivered from the liquid delivery mechanism 30 with a gas; a seal part 322 that is connected to the base part 320 and is slidable while being in tight contact with the entire circumference of the inner peripheral surface of the case body 311; an air-supply structure 323 for delivering air in the space on the lower side (hereinafter referred to as the lower space) 31 out of two spaces sectioned by the base part 320 and the seal part 322 in the case part 31 to the mixing chamber 321 during the liquid delivery action of the liquid delivery mechanism 30; and an intake structure 324 for delivering air from the space on the upper side (hereinafter referred to as the upper space) out of the two spaces sectioned by the base part 320 and the seal part 322 in the case part 31 to the lower side during the liquid suction action of the liquid delivery mechanism 30.

Since the seal part 322 is fixed to the movable cylindrical part 301 via the base part 320 as shown in FIG. 4, the base part 320 and the seal part 322 are configured to reciprocally move (i.e., move upward and downward) together with the movable cylindrical part 301 in the case part 322.

Further, the seal part 322 is arranged on the upper end side in the case part 31 before the liquid delivery mechanism 30 takes the liquid delivery action (i.e., in a non-operated state), to come into the state of covering (i.e., blocking) the inner communication hole 310 from the inside of the case part 31.

On the other hand, the seal part 322 moves from the upper end side to the lower end side in the case part 31 when the liquid delivery mechanism 30 starts the liquid delivery action (i.e., comes into the operated state), and thus comes into the state of being retracted from the position corresponding to the inner communication hole 310 (i.e., the state of keeping the inner communication hole 310 open).

In this embodiment, the seal part 322 thus constitutes an inner opening-closing part that is configured to open the inner communication hole 310 by the liquid delivery action of the liquid delivery mechanism 30, and close the inner communication hole 310 by the liquid suction action of the liquid delivery mechanism 30.

The mixing chamber 321 is configured to communicate with the inside of the movable cylindrical part 301 through the liquid delivery port 3010 when the liquid delivery mechanism 30 takes the liquid delivery action, and to be blocked from communicating with the inside of the movable cylindrical part 301 when the liquid delivery mechanism 30 has completed the liquid suction action (i.e., when the liquid delivery mechanism 30 is in the non-operated state) after the liquid delivery action.

As shown in FIG. 5A and FIG. 5B, the air-supply structure 323 includes an air-supply path 3230 that communicates with the lower space and the mixing chamber 321, and an air-supply valve 3231 that is configured to open the air-supply path 3230 at the time of the liquid delivery action of the liquid delivery mechanism 30, and to close the air-supply path 3230 at the time of the liquid suction action of the liquid delivery mechanism 30.

The intake structure 324 includes an intake path 3240 that communicates with the upper space and the lower space, and an intake valve 3241 that is configured to close the intake path 3240 at the time of the liquid delivery action of the liquid delivery mechanism 30, and to open the intake path 3240 at the time of the liquid suction action of the liquid delivery mechanism 30 (see FIG. 5B).

As shown in FIG. 4, the cover member 4 includes: a cover body 40 that is configured to form a storage space S continuing from the inside of the case part 31 through the inner communication hole 310 between the case part 31 and the cover body 40, while covering the case part 31 in the container 2, and has an outer communication hole 4010 formed to communicate with the storage space S and the inside of the container 2; and an outer opening-closing part 41 that is configured to open the outer communication hole 4010 when the inner pressure of the container 2 becomes lower than the inner pressure of the storage space S, and to close the outer communication hole 4010 when the inner pressure of the container 2 becomes equal to or higher than the inner pressure of the storage space S.

The cover body 40 includes a cylindrical cover side wall 400 and a cover bottom wall 401 arranged to face the container bottom wall 201 side of the container 2, and the outer communication hole 4010 is formed in the cover bottom wall 401. The outer surface of the cover bottom wall 401 of this embodiment is formed to be flat.

The outer opening-closing part 41 includes a fixed part 410 that is fixed to the cover bottom wall 401 and an outer communication valve 411 that is continuing from the fixed part 410 and has a flexibility. The outer communication valve 411 is configured to switch between the state of covering the outer communication hole 4010 from an outside of the cover bottom wall 401 (the state of sealing) and the state of making the outer communication hole 4010 open, according to the pressure condition in the container 2.

The outer communication valve 411 is configured to separate from the outer surface of the cover bottom wall 401 and thereby open the outer communication hole 4010 when the inner pressure of the container 2 becomes lower than the inner pressure of the storage space S, and to cover the outer communication hole 4010 from the outside of the cover bottom wall 401 and thereby block the hole 4010 when the negative pressure in the container 2 is eliminated.

The pump head 33 includes a discharge path 330 through which the liquid mixed with a gas in the mixing chamber 321 is allowed to flow, and a foaming device 331 placed in the discharge path 330 to cause the liquid mixed with the gas to be foamed. The pump head 33 of this embodiment includes two foaming devices 331, but the number of the foaming device is not limited to two.

Further, the pump head 33 can be pushed toward the container 2, and is configured to, when released from the pushing operation, return upward (i.e., to an original position) upon indirectly receiving the biasing force of the biasing device 302.

The retainer 34 is configured to fix the liquid delivery mechanism 30, the case part 31, the air-liquid mixing part 32, and the pump head 33 to the mouth 21. In this embodiment, the retainer 34 is configured to be fixed to (screwed onto) the mouth 21.

The configuration of the dispenser 1 according to this embodiment is described above. Subsequently, the usage of the dispenser 1 will be described.

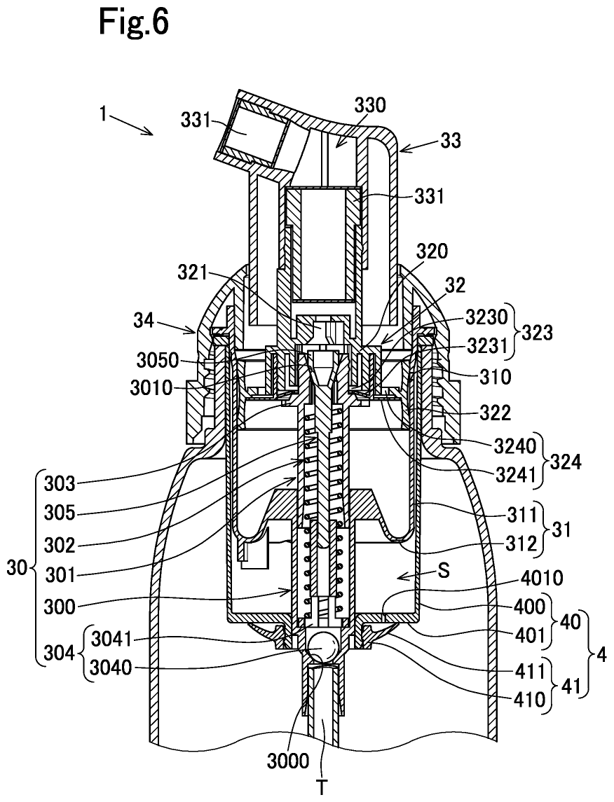

FIG. 6 shows the dispenser 1 in a non-operated state where the dispenser 1 is not being operated by a user. The user pushes the pump head 33 down to this non-operated dispenser 1 and then releases the hand from the pump head 33. This action causes the liquid delivery mechanism 30 to shift to an operated state to take the liquid delivery action and the liquid suction action in order.

The liquid is not filled in the movable cylindrical part 301 and the fixed cylindrical part 300 in the state where the dispenser 1 has never shifted to the operated state. Then, the user repeatedly pushes the pump head 33 down and releases the hand from the pump head 33 to cause the liquid to be suctioned into the movable cylindrical part 301 and the fixed cylindrical part 300.

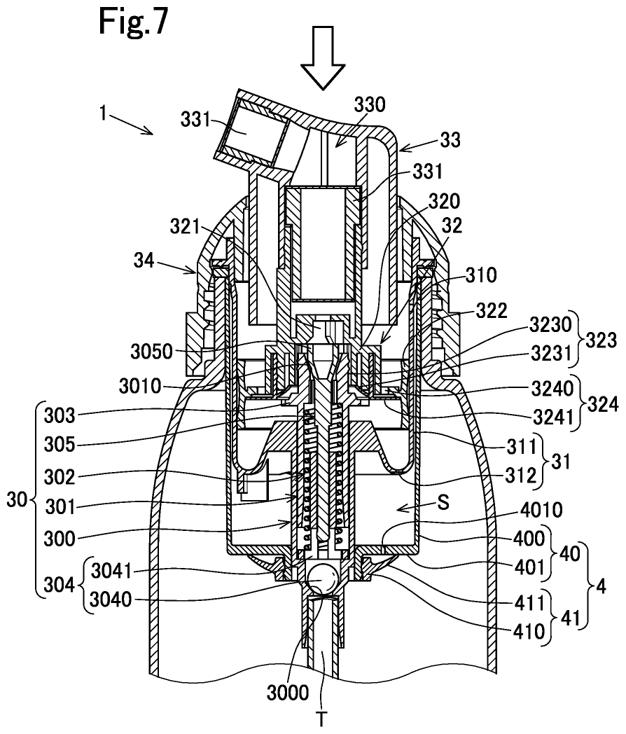

A more detailed description will be given below. As shown in FIG. 7, when the user pushes the pump head 33 down to the non-operated dispenser 1, the movable cylindrical part 301 and the air-liquid mixing part 32 move to the case bottom wall 312 side, while the pump head 33 sinks downward.

When the movable cylindrical part 301 enters the inside of the fixed cylindrical part 300, the volume of the inside of each of the movable cylindrical part 301 and the fixed cylindrical part 300 is decreased. At this time, the liquid suction port 3000 is closed while the liquid delivery port 3010 is opened, so that the liquid filled in the movable cylindrical part 301 and the fixed cylindrical part 300 is fed to the mixing chamber 321 through the liquid delivery port 3010. The liquid delivery mechanism 30 takes the liquid delivery action in this way.

Further, when the air-liquid mixing part 32 moves from the upper end side to the lower end side of the case part 31, the intake valve 3241 closes the intake path 3240 and the air-supply valve 3231 opens the air-supply path 3230. Thus, the air in the lower space is discharged to the mixing chamber 321 through the air-supply path 3230.

Then, the air-containing liquid in the mixing chamber 321 prepared by being mixed with air in the mixing chamber 321 is allowed to pass through the foaming device 331 to change from a liquid state to a foamed state, and be discharged from the pump head 33 to the outside.

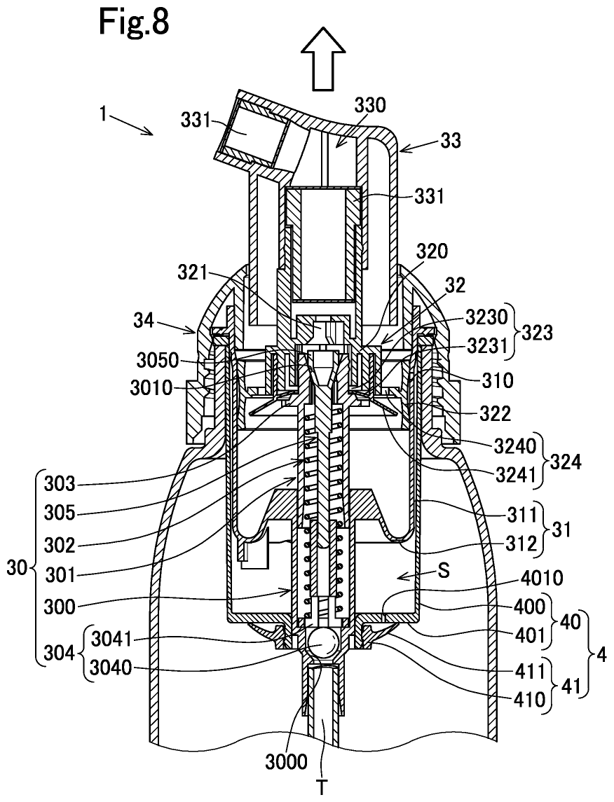

Subsequently, when the user releases the hand from the pump head 33 that has been pushed down, the pump head 33 moves in the direction in which the movable cylindrical part 301 advances toward the fixed cylindrical part 300 by the biasing force of the biasing device 302 (i.e., direction in which the movable cylindrical part 301 moves away from the case bottom wall 312 in the case part 31) as shown in FIG. 8, to cause the liquid delivery mechanism 30 to take the liquid suction action.

When the movable cylindrical part 301 advances from the inside of the fixed cylindrical part 300, the volume of the inside of each of the movable cylindrical part 301 and the fixed cylindrical part 300 increases. At this time, the liquid delivery port 3010 is closed and the liquid suction port 3000 is opened, so that the liquid is drawn into the movable cylindrical part 301 and the fixed cylindrical part 300.

Further, when the air-liquid mixing part 32 moves from the lower end side to the upper end side of the case part 31, the intake valve 3241 opens the intake path 3240 and the air-supply valve 3231 closes the air-supply path 3230. Thus, the air in the upper space is introduced into the lower space through the intake path 3230.

The inner pressure of the container 2 is reduced by an amount equivalent to the amount of the liquid in the container 2 suctioned by the liquid delivery mechanism 30. When the inner pressure of the container 2 becomes lower than the inner pressure of the storage space S, the outer opening-closing part 41 opens the outer communication hole 4010, to cause the outside air to be drawn into the container 2 through the inner communication hole 310, the storage space S, and the outer communication hole 4010. Thereby, the negative pressure in the container 2 is eliminated.

Further, even in the case where the airflow to the inner communication hole 310 is blocked with the negative pressure of the inside of the container 2 not eliminated (for example, in the case where the inner communication hole 310 is blocked by the seal part 322 before the negative pressure of the inside of the container 2 is eliminated), the inner pressure of the container 2 being lower than the inner pressure of the storage space S causes the outer opening-closing part 41 to keep opening the outer communication hole 4010 to cause the air in the storage space S to be drawn into the container 2 through the outer communication hole 4010. Thereby, the negative pressure in the container 2 is eliminated.

As described above, according to the dispenser 1 of this embodiment, the inner opening-closing part opens the inner communication hole 310 to cause the pressure in the container 2 to be reduced by the amount equivalent to the amount of the liquid suctioned by the liquid delivery mechanism 30 in the liquid suction action of the pump unit 3. Then, when the inner pressure of the container 2 becomes lower than the inner pressure of the storage space S, the outer opening-closing part 41 opens the outer communication hole 4010 to cause the air to be drawn into the container 2 through the inner communication hole 310, the storage space S, and the outer communication hole 4010. Thereby, the negative pressure in the container 2 is eliminated.

Further, in the dispenser 1, even in the case where the airflow to the inner communication hole 310 is blocked before the negative pressure in the container 2 is eliminated, the outer opening-closing part 41 keeps opening the outer communication hole 4010 as long as the inner pressure of the container 2 is lower than the inner pressure of the storage space S. Thus, the air in the storage space S is drawn into the container 2 through the outer communication hole 4010.

In this way, since the dispenser 1 of the above configuration can sufficiently draw the air into the container 2 when the liquid delivery mechanism 30 takes the liquid suction action, it is possible to suppress the continuous increase of the negative pressure in the container 2. Thereby, a discharge defect of the liquid that is stored in the container 2 can be suppressed.

Further, in the dispenser 1, the inner communication hole 310, the storage space S, and the outer communication hole 4010 are aligned in this order along the direction in which the air flowing into the inner communication hole 310 and directing into the container 2 flows. Thus, the air that has flown into the inner communication hole 310 is rectified to flow from the inner communication hole 310 to the storage space S, and then from the storage space S to the outer communication hole 4010.

Accordingly, in the dispenser 1 of the above configuration, the flow of the air that flows into the inner communication hole 310 and then directs into the container 2 becomes smooth, and thus the air supply to the container 2 becomes also smooth.

Further, in this embodiment, since the outer communication hole 4010 is blocked by the outer surface of the cover bottom wall 401 formed in flat and this flat outer surface of the cover bottom wall 401 covered by the outer communication valve 411, a gap is hard to occur between the outer surface of the cover bottom wall 401 and the outer communication valve 411. Thus, the sealing properties are enhanced and the evaporation of the liquid stored in the container 2 is also suppressed.

Further, the dispenser 1 has a smaller size (i.e., smaller volume), as the size of the cover member 4 is smaller, and thus the curvature of the outer peripheral surface of the cover side wall 400 is increased. However, the outer surface of the cover bottom wall 401 remains flat, and therefore the dispenser 1 has a configuration that enables to ensure the sealing properties between the outer surface of the cover bottom wall 401 and the outer communication valve 411 regardless of the size of the dispenser 1.

Moreover, in this embodiment, the cover body 40 is provided to isolate the case part 31 from the inside of the container 2, and the outer communication hole 4010 is opened and closed by the outer communication valve 411. Therefore, even in the case where the dispenser 1 is placed not only in an upright position (i.e., position with the container bottom wall 201 arranged on the lower side and the mouth 21 arranged on the upper side) but also in a horizontal position (i.e., position with the container bottom wall 201 and the mouth 21 arranged sideways), it is possible to prevent the liquid in the container 2 from reaching the inner communication hole 310 to cause the liquid leakage, and also possible to prevent the liquid in the container 2 from entering the inside of the case part 31 to thereby change the mixing ratio of the air and the liquid in the mixing chamber 321.

The dispenser according to the present invention is not limited to the aforementioned embodiment, and it is, of course, that various modifications can be made without departing from the gist of the present invention.

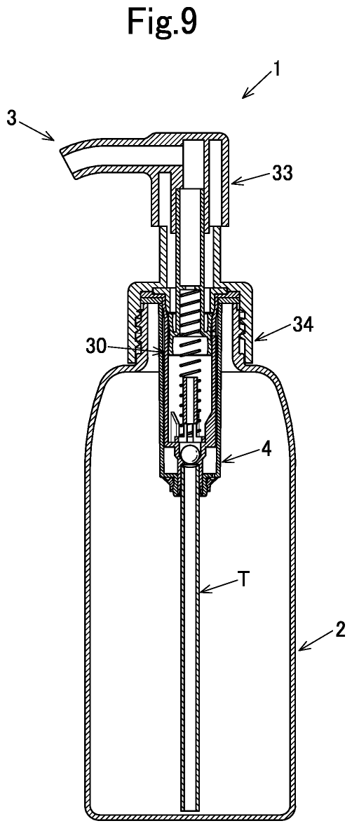

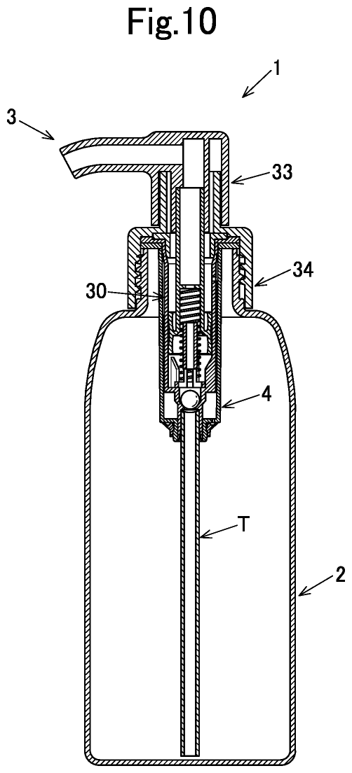

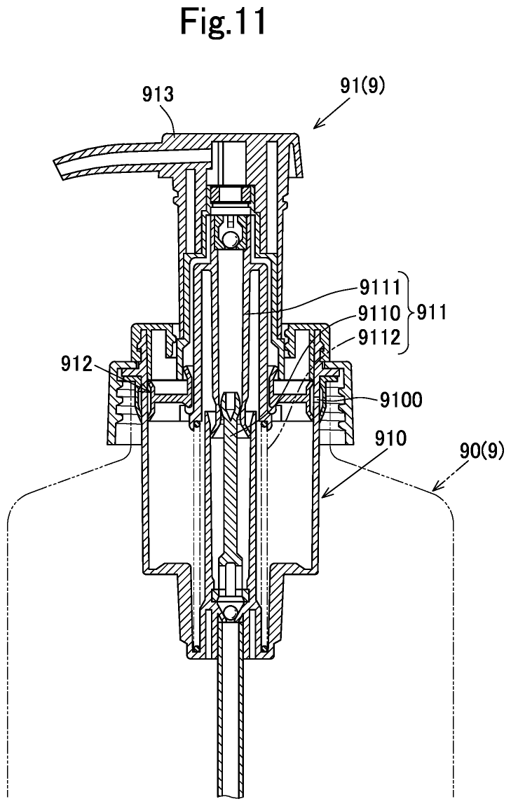

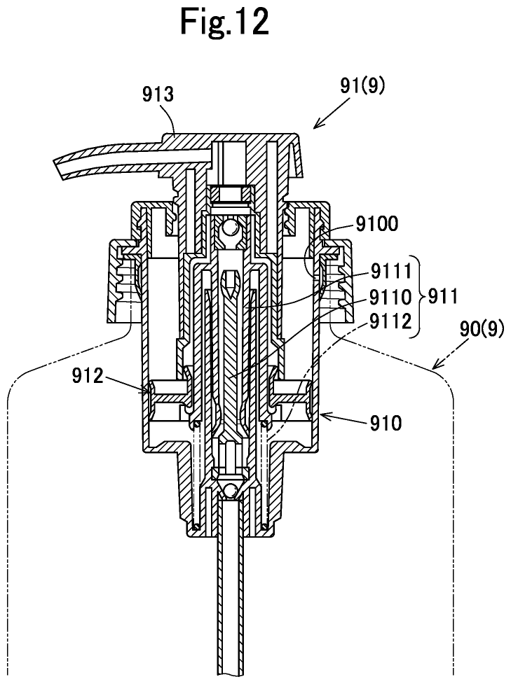

In the above embodiment, the description was given on the dispenser 1 configured to cause the liquid stored in the container 2 to discharge the liquid in a foam form. However, the dispenser 1 can be, for example, as shown in FIG. 9 and FIG. 10, configured to discharge the liquid still in a liquid foam without a structure to foam the liquid.

### REFERENCE SIGNS LIST

1: Dispenser
2: Container
3: Pump unit
4: Cover member
6: Japanese Utility Model Application Laid-Open Publication on Heisei
20: Storing part
21: Mouth
30: Liquid delivery mechanism
31: Case part
32: Air-liquid mixing part
33: Pump head
34: Retainer
40: Cover body
41: Outer opening-closing part
200: Container body
201: Container bottom wall
300: Fixed cylindrical part
301: Movable cylindrical part
302: Biasing device
303: Flange
304: Suction valve
305: Delivery valve
310: Inner communication hole
311: Case body
312: Case bottom wall
320: Base part
321: Mixing chamber
322: Seal part
323: Air-supply structure
324: Intake structure
330: Discharge path
331: Foaming device
401: Cover bottom wall
410: Fixed part
411: Outer communication valve
3000: Liquid suction port
3010: Liquid delivery port
3040: Ball
3050: Opening-closing shaft part
3230: Air-supply path
3231: Air-supply valve
3240: Intake path
3241: Intake valve
4010: Outer communication hole
C: Cap
S: Storage space

1. A dispenser comprising:
a container that stores a liquid;
a pump unit that is attached to a mouth of the container; and
a cover member that is arranged in the container and has a space in which the pump unit can be arranged, wherein
the pump unit comprises:
a liquid delivery mechanism that is configured to take a liquid suction action to suction the liquid in the container, and take a liquid delivery action to deliver the liquid suctioned from the inside of the container;
a case part that has a space in which the liquid delivery mechanism is arranged and has an inner communication hole for providing air communication between the inside and the outside of the case part; and
an inner opening-closing part that is configured to open the inner communication hole by the liquid delivery action of the liquid delivery mechanism, and close the inner communication hole by the liquid suction action of the liquid delivery mechanism, and
the cover member comprises:
a cover body that is configured to form a storage space continuing from an inside of the case part through the inner communication hole between the case part and the cover body, while covering the case part in the container, and has an outer communication hole formed to communicate with the storage space and the inside of the container; and
an outer opening-closing part that is configured to open the outer communication hole when an inner pressure of the container is lower than the inner pressure of the storage space, and close the outer communication hole when the inner pressure of the container is equal to or higher than the inner pressure of the storage space.

2. The dispenser according to claim 1, wherein
the case part has one end arranged on a mouth side of the container and an other end arranged on a bottom wall side of the container,
the cover body has one end arranged on the mouth side of the container and an other end arranged on the bottom wall side of the container,
the inner communication hole is formed on the one end side of the case part, and
the outer communication hole is arranged on the other end side of the cover body.

3. The dispenser according to claim 2, wherein
the inner opening-closing part is configured to, while being in tight contact with an inner peripheral surface of the case part, move in a direction from the one end side of the case part toward the other end side of the case part in the liquid delivery action of the liquid delivery mechanism, and move in a direction from the other end side of the case part toward the one end side of the case part in the liquid suction action of the liquid delivery mechanism,
the inner opening-closing part is configured to be arranged at a closing position to cover the inner communication hole by the movement of the case part in the direction from the other end side toward the one end side, and be retracted from the closing position by the movement of the case part in the direction from the one end side toward the other end side.
